(19) United States
(12) Patent Application Publication
(10) Pub. No.: US 2011/0200016 A1
(43) Pub. Date: Aug. 18, 2011

(54) HARQ ACK/NACK Signalling for Multi-Carrier HSDPA

(76) Inventors: Johan Mikael Bergman, Stockholm (SE); Johan Hultell, Solna (SE); Erik Larsson, Uppsala (SE)

(21) Appl. No.: 13/022,646

(22) Filed: Feb. 8, 2011

Related U.S. Application Data
(60) Provisional application No. 61/304,654, filed on Feb. 15, 2010.
(60) Provisional application No. 61/320,071, filed on Apr. 1, 2010.

(51) Int. Cl. H04B 7/216

(52) U.S. Cl. 370/335

(57) ABSTRACT

Techniques are disclosed for signaling retransmission-related information in a multi-carrier wireless communication system supporting three or more carriers. In an example method, a wireless transceiver forms a first ACK/NACK group by jointly coding ACK bits and NACK bits for a first subset of the carriers, and transmits the first ACK/NACK group during a first transmission slot allocated for the first ACK/NACK group. If no carriers of a second subset of the carriers are activated for the wireless transceiver, then the first ACK/NACK group is also transmitted during a second transmission slot that is otherwise allocated to ACK/NACK information for a second subset of the carriers. In another method, first and second ACK/NACK groups corresponding to first and second subsets of carriers are each formed from a codebook comprising a DTX codeword indicating that no data transmission for the mobile station was detected for the corresponding subset of carriers.

### RELATED APPLICATIONS

This application claims priority under 35 U.S.C. §119(e) to U.S. Provisional Patent Application Ser. No. 61/304,654, filed 15 Feb. 2010, and to U.S. Provisional Patent Application Ser. No. 61/320,071, filed 1 Apr. 2010. The entire contents of both of the foregoing provisional applications are incorporated by reference herein.

### FIELD OF THE INVENTION

The present invention relates generally to retransmission control techniques in communication systems, and more particularly relates to techniques for a mobile station to signal retransmission-related information in a multi-carrier wireless communications system.

### BACKGROUND

The multi-carrier functionality for High-Speed Packet Access (HSPA) is evolving for each release of the 3rd-Generation Partnership Project (3GPP) specifications, starting with the so-called Release 8 (Rel-8) specifications. For Release 9 (Rel-9), one of the introduced features was the combining of dual-carrier High-Speed Downlink Packet Access (HSDPA) with Multiple-Input/Multiple-Output (MIMO) support (DC-HSDPA-MIMO), whereby simultaneous transmission to a single UE can take place on up to two MIMO-capable downlink carriers. Release 10 (Rel-10) HSPA is targeting support for up to four MIMO-capable downlink carriers. One technical issue that needs to be solved is how to design the ACK/NACK feedback signaling to support up to four MIMO-capable carriers.

In HSDPA, downlink data packets are transmitted in the High-Speed Downlink Shared Channel (HS-DSCH), which uses a fixed frame size of two milliseconds. The data transmitted in a single frame is referred to as a transport block. Depending on the coding and modulation scheme employed, a transport block can include from as few as 137 bits to as many as 27,952 bits. Of course, the larger transport block sizes are only possible under very favorable channel conditions.

HSDPA systems use hybrid automatic-repeat-request (hybrid-ARQ, or HARQ) techniques to facilitate retransmission of erroneously received data at the Medium Access Control (MAC) layer. This approach is much quicker than relying on retransmissions at the Radio Link Control (RLC) layer, which is controlled by the radio network controller (RNC), or at higher layers. In HSDPA, HARQ operates at the transport block level, which means that errors are reported for individual transport blocks and retransmissions of an entire transport block is scheduled in response to a reported error. As a result, only a single information bit, a so-called ACK/NACK (acknowledgement/negative-acknowledgement) bit, is required for reporting the received status of each transport block.

To keep the delays associated with a retransmission as small as possible, the receiver (the user equipment, or UE, in the case of HSDPA) must report as quickly as possible whether a transport block was successfully received and decoded. HSDPA utilizes a stop-and-wait feedback process, to keep the signaling overhead low; with this approach an ACK/NACK signal for each transport block is transmitted to the base station (the NodeB, in 3GPP terminology) at a pre-defined fixed time (about five milliseconds) after the reception of the block. Retransmissions are scheduled in response to ACK/NACK bits that indicate a failed reception.

To allow for continuous data flow, HSDPA allows up to eight HARQ processes to run simultaneously. Each process is numbered and has its own buffer. The UE determines which HARQ process a given transport block belongs to from downlink control signaling, and routes it to the appropriate buffer. With this approach, if a transport block is unsuccessfully received on one HARQ process, new data can continue to be sent on other processes even while decoding, ACK/NACK feedback, and retransmission takes place for the first process.

ACK/NACK feedback for HSDPA is transmitted by the UE on the High-Speed Dedicated Physical Control Channel (HS-DPCCH), an uplink channel specifically created to support HSDPA. This physical channel is transmitted using a separate code-division multiplexing (CDM) channelization code, so that it may be transmitted simultaneously with other physical channels while remaining essentially invisible to base stations that do not support HSDPA.

As specified in Release 5 of the HSDPA specifications, HS-DPCCH uses a spreading factor of 256, meaning that each data bit to be sent over the channel (a “channel bit”) is “spread” (i.e., multiplied) by a 256-bit spreading sequence, so that 256 “chips” are transmitted for each bit. Since the transmitted chip rate is 3.84 million chips per second (Mcps) and the HS-DPCCH is organized into two-millisecond subframes, 30 channel bits are sent in each sub-frame. In the case of conventional single-carrier, single-input single-output (SISO) HSDPA, an ACK/NACK bit for a single transport block is encoded to ten bits, for increased reliability, and transmitted in the first third (the first slot) of the sub-frame. The codebook that maps ACK and NACK values to ten encoded bits is quite simple in this case, as an ACK is represented by a sequence of ten 1's while a NACK is represented by a sequence of ten 0's. Channel Quality Information (CQI) is transmitted in the remaining twenty bits of the sub-frame. (For further details, see “3^{rd} Generation Partnership Project; Technical Specification Group Radio Access Network; Multiplexing and Channel Coding (FDD); Release 5,” 3GPP TS 25.212 §4.7, v. 5.10.0 (June 2005), available at http://www.3gpp.org.)

Release 7 of the HSDPA specifications introduced support for multiple-input multiple-output (MIMO) transmissions. In particular, a dual-stream transmit adaptive array (D-TxAA) approach was defined, supporting simultaneous transmission of two independent data streams to compatible terminals and under appropriate signal conditions. With HSDPA-MIMO, up to two transport blocks can be simultaneously transmitted to a UE in any given transmit-time interval (TTI).

HARQ processing is handled separately for each of the two simultaneously transmitted transport blocks in HSDPA-MIMO. This means that twice as much HARQ feedback is required for dual-stream transmission, since one HARQ acknowledgement per stream must be transmitted back to the NodeB. Thus, two ACK/NACK bits are jointly coded to form ten channel bits, and transmitted in the same slot used for the single-stream ACK/NACK message. This results in a slightly more complicated codebook, as four possible combinations of ACK/NACK bits must be mapped to the ten available channel bits. (For further details, see “3^{rd} Generation Partnership Project; Technical Specification Group Radio Access Network; Multiplexing and Channel Coding (FDD); Release 7,” 3GPP TS 25.212 §4.7, v. 7.11.0 (September 2009), available at http://www.3gpp.org.)

Support for multi-carrier transmission in HSDPA complicates the HARQ feedback process even further. As noted above, Release 9 of the 3GPP standards introduces support for dual-carrier HSDPA transmissions. When dual-carrier support is coupled with MIMO techniques, up to two data streams can be transmitted on each carrier. This means that ACK/NACK feedback for as many as four transport blocks must be signaled to the base station, preferably using the same physical resources. 3GPP's solution to this is to encode all of this feedback into the same ten channel bits used previously. The result is a significantly more complex codebook that includes forty-eight codepoints to account for all the possible combinations of ACK, NACK, and DTX (no transmission) states. For further details, see “3^{rd} Generation Partnership Project; Technical Specification Group Radio Access Network; Multiplexing and Channel Coding (FDD); Release 7,” 3GPP TS 25.212 §4.7, v. 9.4.0 (December 2010), available at http://www.3gpp.org.)

With the introduction of 4-carrier HSDPA, the problem of reliably encoding ACK/NACK feedback becomes even more challenging, since as many as eight transport blocks can be transmitted to a single UE in a given TTI. Thus, a new acknowledgement and negative acknowledgement signaling solution is needed to support the handling of retransmissions.

### SUMMARY

Methods and apparatus are disclosed for improving the performance of ACK/NACK feedback signaling in multi-carrier wireless systems such as multi-carrier HSDPA. Several of the disclosed techniques take advantage of temporarily unused ACK/NACK fields when fewer than all of the configured carriers are activated, thus improving the detection performance at the base station. In various embodiments, this is done by repeating ACK/NACK information for one subset of carriers in a field normally allocated to ACK/NACK information for a second subset of carriers. In others, the ACK/NACK codebook is augmented with a DTX codeword, which is transmitted when no data is detected by the UE for any of the activated carriers in a given subset. The disclosed techniques are generally very simple to implement, since they build on the existing Release 9 solution. For some of these approaches, the same coding and codebooks used in Release 9 can be reused.

In one example method for signaling retransmission-related information in a multi-carrier wireless communication system supporting three or more carriers, a first ACK/NACK group is formed in a wireless transceiver by jointly coding ACK bits and NACK bits for a first subset of the carriers, and transmitting the first ACK/NACK group during a first transmission slot allocated for the first ACK/NACK group. This first subset includes at least two of the three or more carriers. Depending on whether any carriers of a second subset of carriers are activated for a transmission interval corresponding to the first ACK/NACK group, the first ACK/NACK group is selectively transmitted during a second transmission slot otherwise allocated to ACK/NACK information for the second subset of the three or more carriers. In particular, if no carriers of the second subset are activated for a transmission interval corresponding to the first ACK/NACK group, then the first ACK/NACK group is transmitted also in this second transmission slot. Otherwise, a second ACK/NACK group is transmitted during this second transmission slot, the second ACK/NACK group being formed by jointly coding ACK bits and NACK bits for the second subset of carriers.

In another example method for signaling retransmission-related information in a multi-carrier wireless communication system supporting three or more carriers, a first ACK/NACK group is again formed by jointly coding ACK bits and NACK bits for a first subset of carriers, the first subset comprising at least two of the three or more carriers. However, in this case the first ACK/NACK group is formed from a codebook comprising a DTX codeword indicating that no transport block was detected by the UE as scheduled for the corresponding subset of carriers. A second ACK/NACK group is formed in a similar way, by jointly coding ACK bits and NACK bits for a second subset of carriers, the second subset comprising at least one of the three or more carriers. Again, the ACK/NACK groups is formed from a codebook comprising a DTX codeword indicating that no transport block was detected for the corresponding subset. The first and second ACK/NACK groups are then transmitted in first and second uplink transmission slots, respectively.

In some embodiments of this second technique, either the first ACK/NACK group or the second ACK/NACK group may comprise the DTX codeword for any given transmission of the first ACK/NACK group and the second ACK/NACK group, but not both. In some embodiments, the codebook comprises the codebook specified for Release 9 of the 3GPP specifications, with the addition of the DTX codeword.

Mobile station and base station apparatus corresponding generally to the methods summarized above are also disclosed, and include processing circuits configured to carry out one or more of the techniques described herein for signaling and processing retransmission-related information. Of course, those skilled in the art will appreciate that the present invention is not limited to the above features, advantages, contexts or examples, and will recognize additional features and advantages upon reading the following detailed description and upon viewing the accompanying drawings.

### BRIEF DESCRIPTION OF THE DRAWINGS

FIG. 1 illustrates a wireless communication system in accordance with some embodiments of the present invention.

FIG. 2 is a block diagram illustrating elements of a retransmission control system.

FIG. 3 is a process flow diagram illustrating a method for signaling retransmission information in a multi-carrier wireless communication system.

FIG. 4 is another process flow diagram illustrating another method for signaling retransmission information in a multi-carrier wireless communication system.

FIG. 5 is another process flow diagram illustrating another method for signaling retransmission information in a multi-carrier wireless communication system.

FIG. 6 is a block diagram of an example mobile station configured according to some embodiments of the present invention.

FIG. 7 illustrates a mobile station control circuit according to some embodiments of the present invention.

FIG. 8 is a block diagram of an example base station configured according to some embodiments of the present invention.

FIG. 9 illustrates a base station control circuit according to some embodiments of the present invention.

FIG. 10 is a process flow diagram illustrating a method for processing retransmission information in a multi-carrier wireless communication system.

FIG. 11 is a table illustrating an example mapping of code numbers to detection scenarios for joint coding of ACK/NACK information for two carriers.

### DETAILED DESCRIPTION

Various embodiments of the present invention are now described with reference to the drawings, wherein like reference numerals are used to refer to like elements throughout. In the following description, numerous specific details are set forth for purposes of explanation, in order to provide a thorough understanding of one or more embodiments. It will be evident to one of ordinary skill in the art, however, that some embodiments of the present invention may be implemented or practiced without one or more of these specific details. In other instances, well-known structures and devices are shown in block diagram form in order to facilitate describing embodiments.

While the following discussion focuses on retransmission control signaling in a High-Speed Packet Access (HSPA) system, the techniques described herein can be applied to various wireless communication systems configured for multi-carrier support, including those that use code division multiple access (CDMA), time division multiple access (TDMA), frequency division multiple access (FDMA), orthogonal frequency division multiple access (OFDMA), single carrier-frequency division multiple access (SC-FDMA), or other radio access and modulation schemes. CDMA-based systems include those that are based on specifications for Universal Terrestrial Radio Access (UTRA), CDMA2000, etc. UTRA in turn includes Wideband-CDMA (W-CDMA) and other variants of CDMA, while CDMA2000 includes IS-2000, IS-95 and IS-856 standards. Well-known TDMA systems include the Global System for Mobile Communications (GSM), while systems based on OFDMA include Evolved UTRA (E-UTRA), Ultra Mobile Broadband (UMB), IEEE 802.11 (Wi-Fi), IEEE 802.16 (WiMAX), IEEE 802.20, Flash-OFDM, etc.

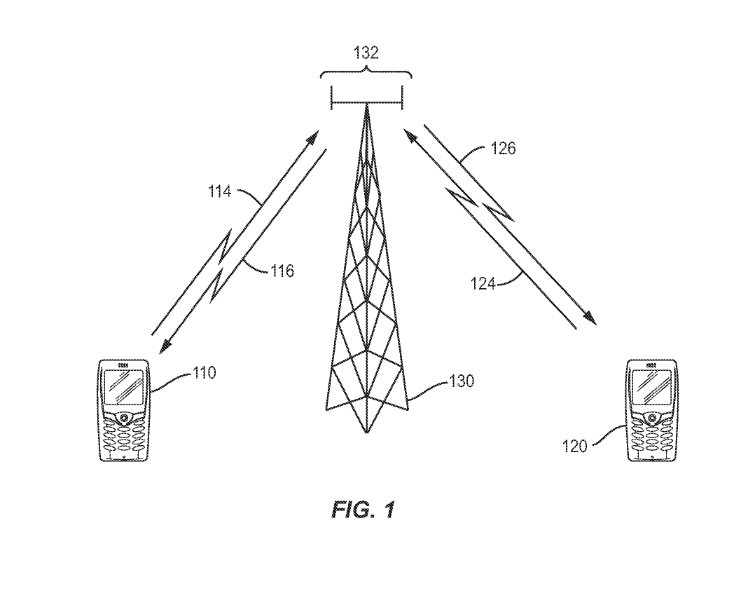

FIG. 1 illustrates components of a wireless network 100, including mobile stations 110 and 120 and base station 130. Base station 130 communicates with mobile stations 110 and 120 via one or more antennas 132; individual ones or groups of these antennas are used to serve pre-defined sectors and/or to support any of various multi-antenna transmission schemes, such as multiple-input multiple-output (MIMO) transmission schemes. In the system illustrated in FIG. 1, mobile station 110 is communicating with base station 130 over an uplink (mobile station-to-base station) 114 and a downlink (base station-to-mobile station) 116. Similarly, mobile station 120 is communicating with base station 130 over an uplink 124 and a downlink 126.

Several of the embodiments are described herein in connection with a wireless transceiver in a radio access terminal, such as the mobile stations 110 and 120 illustrated in FIG. 1. A radio access terminal, which communicates wirelessly with fixed base stations in the wireless network, can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem.

Similarly, various embodiments are described herein in connection with a wireless base station, such as the base station 130 illustrated in FIG. 1. The wireless base station 130 communicates with access terminals and is referred to in various contexts as an access point, Node B, Evolved Node B (eNodeB or eNB) or some other terminology. Although the various base stations discussed herein are generally described and illustrated as though each base station is a single physical entity, those skilled in the art will recognize that various physical configurations are possible, including those in which the functional aspects discussed here are split between two physically separated units. Thus, the term “base station” is used herein to refer to a collection of functional elements (one of which is a radio transceiver that communicates wirelessly with one or more mobile stations), which may or may not be implemented as a single physical unit.

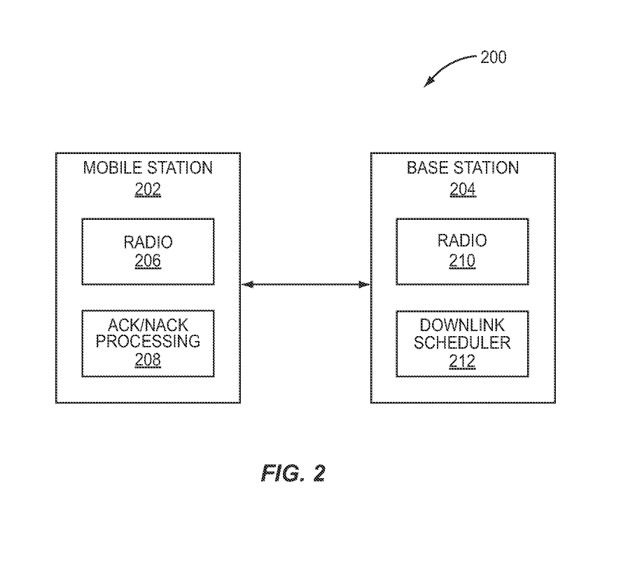

FIG. 2 is a block diagram illustrating a few of the functional elements relevant to retransmission processing in a wireless communication system. System 200 includes a mobile station 202, which communicates with a base station 204 via a downlink and uplink. (The terms “forward link” and “reverse link” are sometimes used instead of “downlink” and “uplink”.) Mobile station 202 includes radio circuitry 206 and ACK/NACK processing circuit 208, while base station 204 includes corresponding radio circuitry 210 and a downlink scheduler 212. These functional modules, which may be implemented as electronic hardware or as a combination of hardware and software, interact according to one or several of the techniques described herein to perform retransmission-related processing.

As noted above, the 3^{rd}-Generation Partnership Project is developing standards for multi-carrier support in High-Speed Downlink Packet Access (HSDPA) systems. In particular, specifications are being written to enable the simultaneous reception of up to four HSDPA carriers by a mobile terminal, such as mobile stations 110 and 120 in FIG. 1 and mobile station 202 in FIG. 2.

With the introduction of 4-carrier HSDPA, a new acknowledgement (ACK) and negative acknowledgement (NACK) signaling solution is needed to support the handling of retransmissions. Because a hybrid ARQ (HARQ) process will be carried out for each of the up to four carriers, any or all of which may be configured for single- or dual-stream operation, the system must support eight flows of ACK/NACKs. This requirement raises a number of new issues.

First, support for HARQ in a 4-carrier system requires significantly more feedback, compared to Dual-Cell HSDPA (DC-HSDPA) as specified in 3GPP's Release 9 standards. It is not feasible to fit all of the required feedback into the High-Speed Dedicated Physical Control Channel (HS-DPCCH) format as defined for Release 9. Release 9 specifies that the HS-DPCCH shall use one channelization code with spreading factor of 256 (a format referred to as 1×SF256). To support 4-carrier HSDPA, the use of either 2×SF256 (two channelization codes, each applied with spreading factors of 256) or 1×SF128 (one channelization code, with a spreading factor of 128) has been discussed. Given the same time interval allocated for ACK/NACK reporting in the Release 9 specifications, either of these alternatives would provide twice the number of channel bits (20 instead of 10) to convey the ACK/NACK information.

Another issue to be addressed is the flexibility of the feedback solution. Because the new systems will support up to four carriers, each of which can be configured for either single stream (Single-Input Single-Output, or SISO) or dual-stream (Multiple-Input Multiple-Output, or MIMO) operation, several carrier configurations will be possible at any given time. These configurations could change semi-statically, i.e. based on higher-layer signaling, or they could change dynamically, i.e. based on High-Speed Shared Control Channel (HS-SCCH) orders.

More particularly, when a UE is configured or 4-carrier operation, up to four carriers can be configured by the RNC. The serving Node-B dynamically controls which of these carriers that are activated (and deactivated). This is done by transmitting layer-1 HS-SCCH orders. For any given transmission time interval, the Node-B is free to select which of the carriers it wishes to use to schedule data, from among the currently activated downlink carriers. Thus, at any given time a carrier can be activated for a particular mobile station even though the Node-B has not currently scheduled any data for the mobile station on the carrier. It is possible to conceive of a system that uses a different feedback solution for each of several different configurations, i.e., depending on which carriers are configured/activated at a given time and depending on how many carriers are configured to support MIMO operation.

However, to minimize the work required to develop and deploy the new systems, it is desirable to re-use as much as possible from previous releases. To that end, it has been proposed to re-use the ACK/NACK codebook specified for Release 9 (see 3GPP TS 25.212 §4.7, v.9.4.0) unless clear technical gains from changing the codebook can be demonstrated. One benefit of the Release 9 codebook is that the number of codewords is kept low by taking into account the system's knowledge of the number of scheduled carriers and streams. In this manner, several codewords can have different meanings, depending on the current carrier configuration.

Given the above discussion, a baseline feedback solution to support multi-carrier operation in Release 10 HSPA systems can be described. As an initial matter, it can be assumed for the sake of discussion that twenty channel bits will be available to convey the ACK/NACK information. Whether these twenty bits are obtained by adopting a SF128 solution or by using two SF256 codes is not particularly significant to the ACK/NACK signaling solution. Of course, the signal format will affect other things, such as the cubic metric for the transmitted signal.

Next, the four carriers can be divided into two groups, with two carriers in each group. For example, let G1={carrier1, carrier2} and G2={carrier3, carrier4}. ACK/NACK information for each group (G1 and G2) can be coded independently of the ACK/NACK information for the other group, using the codebook currently standardized in Release 9. Then, the coded information for the first group (G1) is transmitted in a first slot, using the first ten ACK/NACK bits, and the coded information for G2 is transmitted in a second slot, using the last 10 bits. If the extra bits are obtained by using a 1×SF128 format for the HS-DPCCH, these two slots are time-multiplexed so that the total time duration during which the HARQ-ACK information is sent amounts to one third of the TTI. If a 2×SF256 format is used instead, the ACK/NACK information for the two carrier groups may be (but is not necessarily) transmitted simultaneously.

This baseline ACK/NACK solution is essentially based on a mechanism where carriers are grouped two and two, and coding/decoding is done per group, i.e., ACK/NACK information for two carriers at a time are coded/decoded jointly. Depending on whether the base station has scheduled SISO/SISO, SISO/MIMO, MIMO/SISO or MIMO/MIMO transmissions for each carrier pair, different codewords are used to convey the ACK/NACK information transmitted back to the base station.

Given this baseline approach, since the ACK/NACK information for each group (G1 and G2) is encoded independently, the two codewords can also be detected and decoded independently. However, in general it is the detection performance that determines the overall ACK/NACK performance—in turn, the detection performance is determined by the number of codewords and the codeword length, as longer codewords provide more detection energy. Consequently, detecting the HARQ ACK/NACK independently for the two groups sacrifices some detection energy, since each detection process considers a 10-bit codeword rather than a 20-bit codeword.

A distinct but related issue arises when some of the carriers are deactivated. More specifically, if the carriers in G2 are deactivated, then no energy is transmitted in the time slot for G2 ACK/NACK information. In this scenario, it would be desirable to have similar uplink coverage as seen in dual-cell operation under the Release 9 standards. However, since the re-formatted HS-DPCCH will provide less energy for the G1 ACK/NACK information (compared to a similar message transmitted under the Release 9 standards), this will not be the case if the baseline operation described above is applied.

The performance of a time-multiplexed ACK/NACK feedback signaling solution for some carriers in a multi-carrier HSDPA system can be improved by taking advantage of temporarily unused ACK/NACK fields for other carriers. In various embodiments, this is done by applying repetition, or by including Discontinuous Transmission (DTX) codewords to aid the receiver detector. Although the techniques are generally described herein with respect to four-carrier HSDPA, those skilled in the art will recognize that the techniques can be applied in other multi-carrier systems employing three or more carriers.

The inventive techniques are best understood by beginning again with the baseline ACK/NACK feedback solution proposed for 3GPP's Release 10 and summarized above. In total there are twenty channel bits to convey the ACK/NACK information. Whether these twenty bits are obtained by means of a 1×SF128 or 2×SF256 format for the HS-DPCCH is of less concern for the ACK/NACK signaling solutions disclosed herein. This choice will, however, affect other things such as the cubic metric (required power back-off).

The four carriers in the 4-carrier Release 10 system can be divided into two groups with two carriers in each group. Obviously, a number of different carrier-to-group mappings can be envisioned. In order to avoid complicated and error-prone rearrangements of the mapping between the up to four carriers and the different HS-DPCCH information fields, a semi-static mapping such as the following should be used: Group 1 (G1) consists of carrier 1 and carrier 2, where carrier 1 corresponds to the serving High-Speed Downlink Shared Channel (HS-DSCH) cell and carrier 2 corresponds to the secondary serving HS-DSCH cell (as specified in Release 8 and 9), which may have a corresponding secondary uplink frequency; Group 2 (G2) consists of carriers 3 and 4, which may not have corresponding secondary uplink frequencies.

The ACK/NACK information for each group (G1 and G2) is coded independently of the other, using the Release 9 codebook. The coded information for G1 is transmitted using the first 10 ACK/NACK bits and the coded information for G2 is transmitted using the last 10 bits, i.e., using time-multiplexing for an SF128 solution.

As mentioned earlier, one of the drawbacks of detecting G1 and G2 independently is that some of the detection energy is sacrificed, since the detector is considering length-10 codes instead of length-20 codes. This is true in general, but the problem is aggravated in scenarios where some carriers are deactivated or where transmissions from the Node-B only takes place on some carriers, so that HARQ-ACK feedback for all groups is not transmitted. One way of improving the detection performance is to base the detector on joint detection of the ACK/NACK information for G1 and G2. Several approaches to this are discussed below.

In a first approach, ACK/NACK information for a carrier group is repeated under certain circumstances. In particular, when the carrier or carriers in G2 are deactivated, then the G1 ACK/NACK bits can be repeated during the time interval during which the G2 bits would otherwise have been transmitted. This results in 3 dB more detection and decoding energy for the G1 ACK/NACK bits. To take full advantage of this additional energy, the receiver at the base station (NodeB, in 3GPP terminology) must behave differently depending on whether the mobile station (user equipment, or UE, in 3GPP terminology) is currently using repetition or not. However, the base station is “aware” of the downlink carrier activation status, and since deactivation is done dynamically by means of HS-SCCH orders, which are acknowledged, the probability that the NodeB and the mobile station “misunderstand” each other is relatively small.

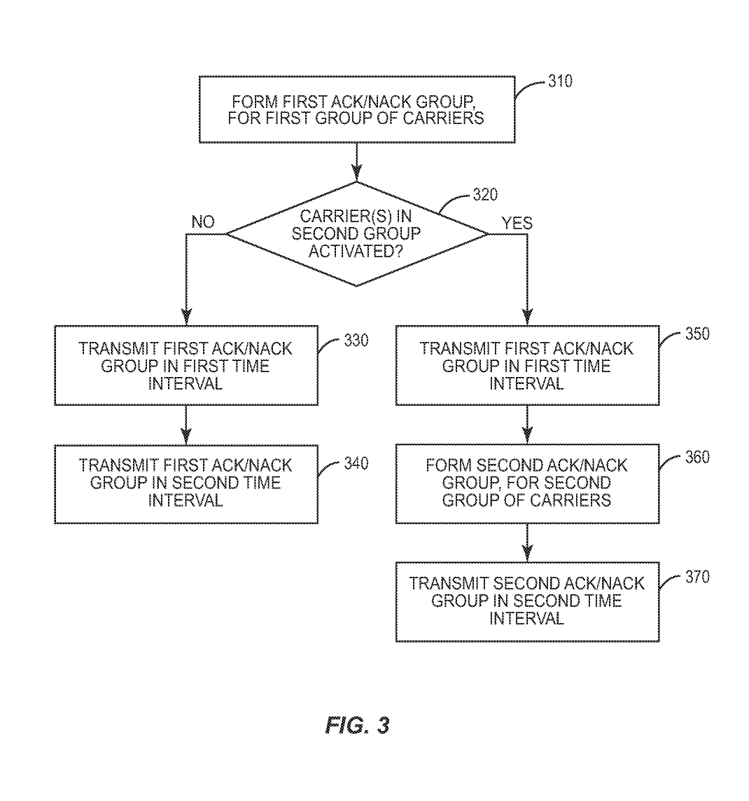

The process flow diagram of FIG. 3 illustrates a generalized embodiment of this approach, as might be implemented in a mobile station, for example. As shown at block 310, a first group of ACK/NACK bits, e.g., an ACK/NACK codeword, is formed for a first group of carriers. This first group of carriers is a subset of the available carriers in a multi-carrier system. Thus, for example, the first group comprises two out of the possible four carriers in a four-carrier HSDPA system. The group of ACK/NACK bits for this first subset of carriers is selected from a look-up table, in some embodiments, where a set of codewords is mapped to the possible ACK/NACK messages that the receiver needs to send in response to receiving (or not) a scheduled downlink transmission. Those skilled in the art will appreciate that certain codewords may be reused for different downlink transmission scenarios, such as SISO/SISO transmission, SISO/MIMO, MIMO/SISO, MIMO/MIMO, etc. An example codebook for coding ACK/NACK responses for two carriers is given in the Release 9 standards, in particular at 3GPP TS 25.212 §4.7, v. 9.4.0 (December 2010).

As indicated at block 320, subsequent ACK/NACK processing depends on whether one or more carriers in a second group of carriers (i.e., a second subset of the available carriers in the multi-carrier system) are currently activated. Note that here the term “activated” here means that the carrier can be selected by the Node-B for transmitting data to a given mobile station in the current transmission/retransmission cycle. For example, even if all four carriers in a four-carrier HSDPA system are configured for use from a Radio Network Controller perspective, the serving base station may selectively deactivate one or more of the configured downlink carriers via HS-SCCH orders, so that only a subset of the carriers for any given transmission cycle is available for downlink transmissions.

If one or more carriers in the second group are activated, then the first ACK/NACK group is transmitted in a first uplink transmission slot specifically allocated to ACK/NACK data for the first group, as shown at block 350. A second group of ACK/NACK bits is formed for the second subset of carriers, as shown at block 360, and transmitted in a second slot specifically allocated for that purpose, as shown at block 370. The second group of ACK/NACK bits can be formed using the same codebook as was used for the first group of carriers, such as the Release 9 codebook.

If, on the other hand, no carriers in the second group are activated, then the slot normally allocated for ACK/NACK feedback for the second group is available. In this case, then, the ACK/NACK feedback for the first subset of carriers can be transmitted twice. This is shown at blocks 330 and 340, which illustrate that the first group of ACK/NACK bits is transmitted in the first slot and in the second slot, the latter of which would otherwise be allocated to ACK/NACK information for the second subset of carriers.

It should be noted that as used herein, the term “transmission slot” is intended to refer generically to a pre-defined set of transmission resources, and is not limited to any particular “slot” as that term might be used in one or more wireless standards. Thus, the first and second uplink transmission slots discussed above could refer to time-frequency resources occupying two distinct intervals of time, i.e., time-multiplexed, as described herein. However, the first and second uplink transmission slots could also be code-multiplexed or frequency-multiplexed, in some embodiments, and thus transmitted simultaneously or in overlapping time intervals.

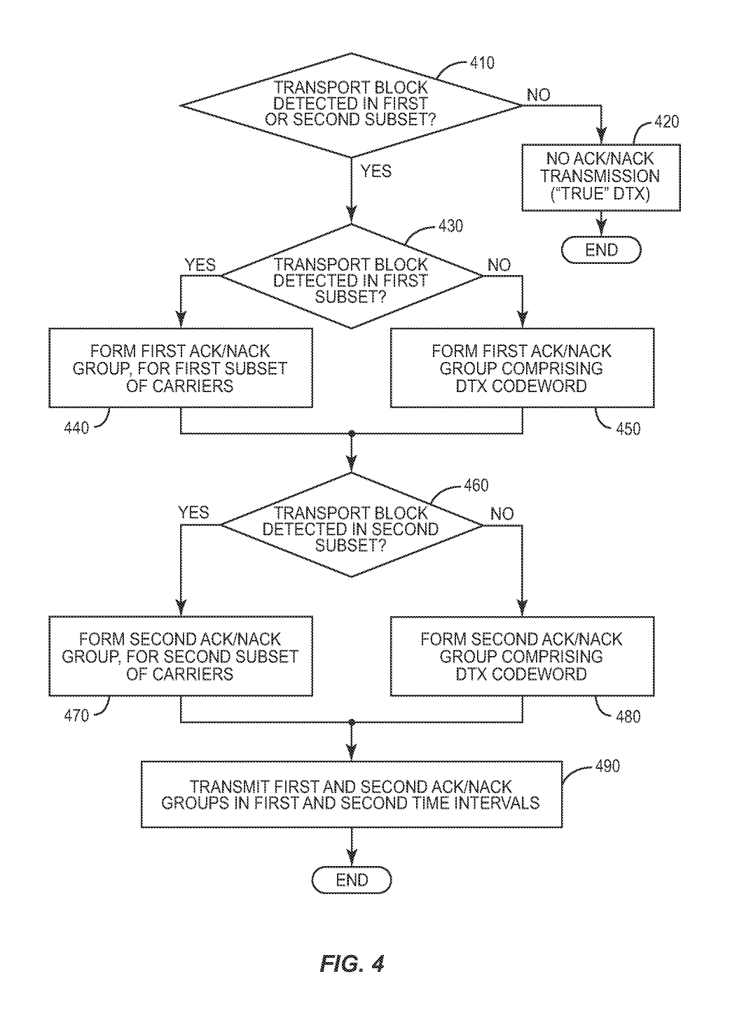

Another approach, illustrated in the process flow diagram of FIG. 4, is also based on the idea that the NodeB detector should jointly detect ACK/NACK information for G1 and G2. In essence, G1 and G2 are decoded independently, but the detection process is based on both G1 and G2. Once again, this implies that the detector is working with 3 dB more detection energy. This is important, since in general it is the detection performance that limits the overall performance of a link. As discussed above, one approach is to repeat the ACK/NACK information for G1 carriers in the slot otherwise used for G2 information, when the G2 carriers are deactivated. A second approach is to augment the existing Release 9 codebook with a DTX codeword. With this approach, the DTX codeword is transmitted in the appropriate slot if no transport block is detected by the UE for any of the activated downlink carriers in either of the groups (but not both), and are thus to be “DTX'ed.” Introducing a DTX codeword for this scenario ensures that the 3 dB extra detection energy is always available to the detector, and that half-slot transmissions (i.e. power changes within a slot) can be avoided. If the UE doesn't detect any transmission on any of the active downlink carriers (i.e., no detected transport blocks from either group G1 or G2), on the other hand, then the mobile station transmits no ACK/NACK feedback in the uplink at all (true DTX).

An embodiment of this approach, as might be implemented in a mobile station, for example, is illustrated in FIG. 4, which illustrates the technique for a single transmission interval. If no transmissions for the mobile station on active carriers in either a first or second subset of the carriers available to the multi-carrier system are detected in that transmission interval, then there is no subsequent ACK/NACK transmission at all, as shown at blocks 410 and 420. This event represents a “true” DTX scenario. If a transmission for the mobile station on one or more carriers is detected, on the other hand, then processing continues, as indicated at block 430.

If a transport block for the mobile station is detected on one or more carriers in the first subset (e.g., via a HS-SCCH in HSDPA systems), then a first group of ACK/NACK bits is formed for the first subset of carriers, as indicated at block 440. This group of ACK/NACK bits is a codeword selected from the current Release 9 codebook, in some embodiments. If no transmissions for the mobile station on carriers in the first subset are detected, however, then a group of ACK/NACK bits that specifically indicates no transmission, i.e., a DTX codeword, is formed, as shown at block 450.

A similar process is carried out for the one or more carriers in the second subset of carriers. If a transmission on one or more carriers in the second subset is detected (e.g., via a HS-SCCH, in HSDPA systems), then a second group of ACK/NACK bits is formed for the second subset of carriers, as indicated at block 470. Again, in some embodiments this group of ACK/NACK bits is a codeword selected from the current Release 9 codebook. If no transmission on carriers in the second subset is detected, however, then a group of ACK/NACK bits that specifically indicates no transmission, i.e., a DTX codeword, is formed, as shown at block 480.

As shown at block 490, the first and second groups of ACK/NACK bits are transmitted to the base station in first and second slots (e.g., first and second time intervals, in a system that uses a 1×SF128 format for the HS-DPCCH). It should be noted that the logic of the process flow diagram in FIG. 4 is such that DTX codewords are never formed for both subsets of carriers. Thus, one or the other of the first and second transmitted codewords may be a DTX codeword, but not both. This characteristic of the process illustrated in FIG. 4 is not essential, however, as a solution in which DTX codewords are transmitted for both subsets of carriers (when no transmission at all is detected) is possible.

Generally speaking, the drawback of introducing a DTX codeword to an existing ACK/NACK codebook is that the decoding performance of the codebook might get slightly worse with the addition of a new codeword. However, it turns out that it is possible to add a new codeword to the Rel-9 codebook without sacrificing much of the codebook minimum distance properties. One such codeword is given below:

DTX=[0 0 1 1 0 0 1 0 1 0]. (1)

Another is given by:

DTX=[0 0 1 1 0 1 1 0 1 0]. (2)

The second DTX codeword (2) given above has superior minimum distance properties (Hamming distances) in certain scenarios, compared to the first DTX codeword (1). For example, when the NodeB schedules single-stream transmissions on each of the carriers in a carrier group (a scenario designated as SISO/SISO, for Single-Input Single-Output/Single-Input Single Output transmission), it turns out that the minimum distance property of the effective codebook using DTX codeword (2) is 4, compared to a minimum distance of 3 when using DTX codeword (1). This means that the ACK/NACK performance improves when using DTX codeword (2) instead of DTX codeword (1).

While good performance can be obtained by augmenting the existing Release 9 codebook with a DTX codeword, even better performance could be obtained if the Release 9 codebook were re-designed (i.e., if a codebook including a DTX codeword were designed from the beginning). As noted earlier, the main benefit of introducing a DTX codeword is that the 3 dB extra detection energy is always available to the detector and that half-slot transmissions (i.e. power changes within a slot) can be avoided. Finally, the decoding complexity with this solution is only about twice the decoding complexity for the current Release 9 solution—this can be considered a modest increase.

Still another approach to improve the ACK/NACK performance in a multi-carrier system using more than two carriers is to consider joint coding of the ACK/NACK information of the carrier groups G1 and G2. However, compared to the ideas presented above, this would have a significantly larger impact on existing standards. For example, the Release 9 codebook would have to be re-designed. On the other hand, this approach can have significantly better performance than when doing independent coding between G1 and G2.

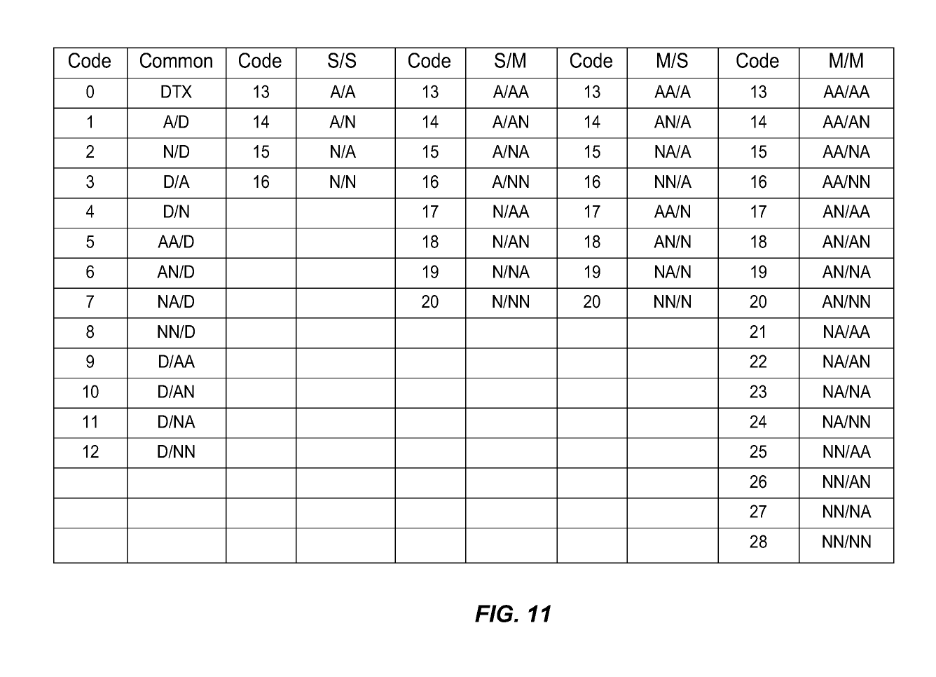

In one approach to joint coding, carriers are still grouped into two (or more) subsets, e.g., carrier groups G1 and G1, to limit the complexity and degrees of freedom. In essence, only the third step of the baseline Rel-10 ACK/NACK feedback solution described above is changed. This new third step has several components. First, given the HS-SCCH detection decision, SISO/SISO (S/S), SISO/MIMO (S/M), MIMO/SISO (M/S), MIMO/MIMO (M/M), for each group G1 and G2, code numbers i₁ and i₂, corresponding to G1 and G2 respectively, are selected. Each of these code numbers can be represented in five bits, i.e., ranges from 0 to 31. One possible set of code numbers is illustrated in FIG. 11—those skilled in the art will appreciate that some of these code numbers are “common,” in that they apply to several different carrier configurations (SISO/SISO, MIMO/MIMO, etc.), while others have different meanings depending on the configuration.

Then, if:

a=[a₀, a₁, . . . , a₁₀]=[lin2bin(i₁;5)lin2bin(i₂;5)] (3)

then a codeword is given by b=[b₀, b₁, . . . , b₁₀], where

$${b}_{i} = {\sum }_{k}^{n} ( {a}_{m} \times {M}_{i , k} ) mod 2 , \qquad ( 4 )$$

for i=0, 1, . . . , 19. The generator matrix M can be the same as is used for CQI MIMO coding, as given, for example, in 3GPP TS 25.212, §4.7.2.2 (Release 7). A benefit of this solution is that it is relatively simple compared to a fully flexible solution, and the codebook properties are very good, in terms of minimum distance properties, since the coding uses length-20 codes, instead of length-10 codes as in the previous proposals. Furthermore, the number of codewords is kept low by re-using the Release 9 idea of taking into account the current transmission configuration, i.e., the momentary number of streams and carriers transmitted in the downlink, when deciding the codewords. The main drawback is that the decoding complexity increases by the power of two compared to the previous solutions. Furthermore, the Release 9 codebook is not re-used.

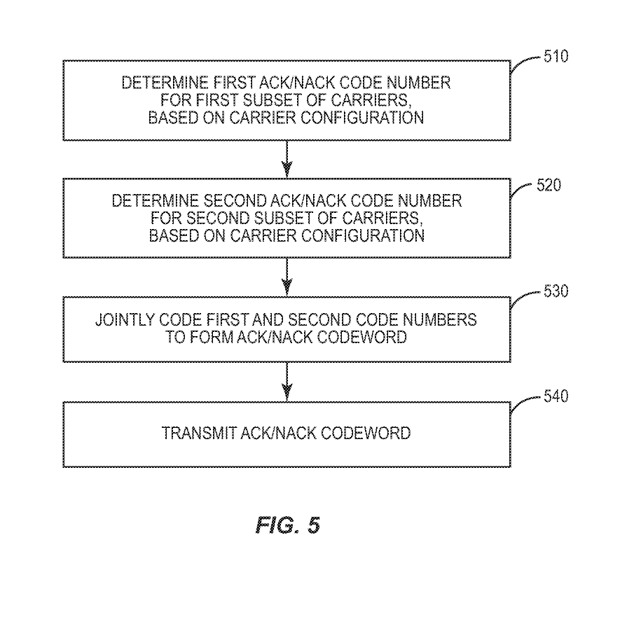

A generalized process flow diagram illustrating the joint coding approach is illustrated in FIG. 5. As shown at blocks 510 and 520, first and second ACK/NACK code numbers are determined for first and second subsets of carriers, respectively. These code numbers are based in part on the carrier configuration, and reflect the various possible feedback messages for each configuration. These code numbers are independent of one another in that the carrier configuration and the transmission state for each of the two subsets are independent.

As shown at block 530, these first and second code numbers are jointly coded to form a single ACK/NACK codeword. The codeword is then transmitted, as shown at block 540. Given the Release 10 assumptions discussed above, 20 channel bits are available for this codeword, allowing for a codebook design that has excellent minimum distance properties.

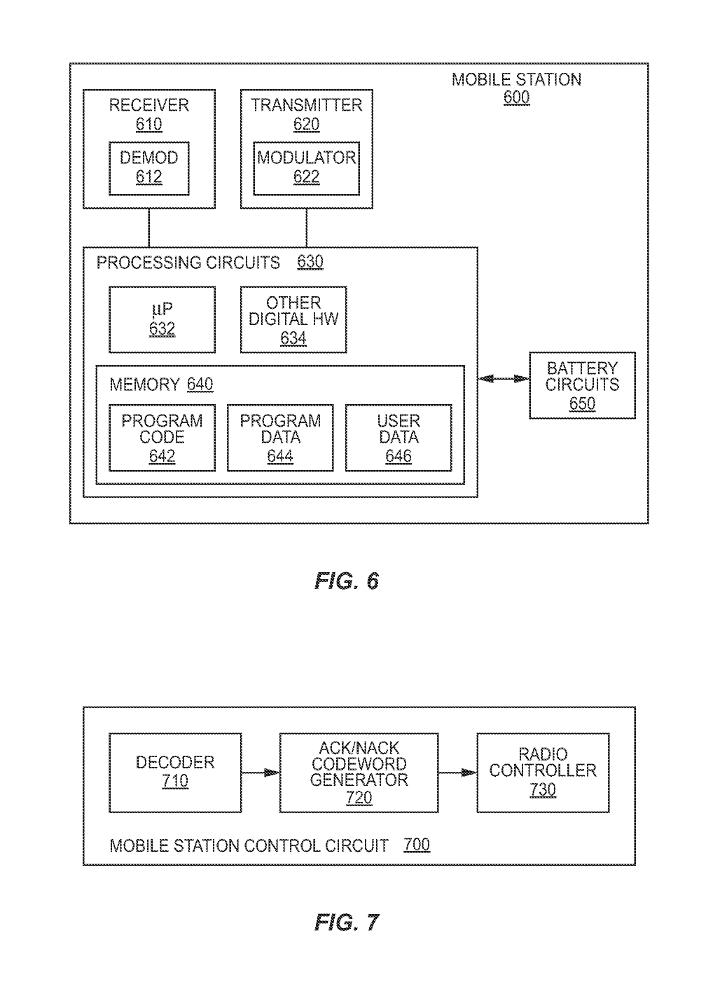

FIG. 6 is a block diagram of a mobile station 600 configured to signal retransmission-related information in a multi-carrier wireless communication system according to the techniques disclosed herein. In particular, mobile station 600 may be configured to implement the methods illustrated in FIGS. 3, 4, and/or 5, or variants thereof. Mobile station 600 includes a receiver circuit 610, which includes various radio-frequency components (not shown) and a demodulator circuit 612. Receiver 610 processes radio signals received from one or more wireless base station and processes the signals, using known radio processing and signal processing techniques, to convert the received radio signals into digital samples for processing by processor circuits 630. More particularly, receiver 610 is capable of receiving and processing multiple carriers simultaneously. Processing circuits 630 extract data from signals received via receiver 610 and generate information for transmission to the wireless base station via transmitter circuit 620, including ACK/NACK information. Like the receiver 610 and demodulator 612, transmitter 620 and modulator 622 use known radio processing and signal processing components and techniques, typically according to one or more telecommunications standards, and are configured to format digital data and generate and condition a radio signal, from that data, for transmission over the air.

Processing circuits 630 comprise one or several microprocessors 632, digital signal processors, and the like, as well as other digital hardware 634 and memory circuit 640. Memory 640, which may comprise one or several types of memory such as read-only memory (ROM), random-access memory, cache memory, flash memory devices, optical storage devices, etc., stores program code 642 for executing one or more telecommunications and/or data communications protocols and for carrying out one or more of the techniques for signaling retransmission-related information described herein. Memory 640 further stores program data 644, user data 646 received from the wireless base station and to be transmitted to the base station, and also stores various parameters, pre-determined threshold values, and/or other program data for controlling the operation of the mobile station 600. Mobile station 600 obviously includes various other feature that are not shown, in addition to the battery circuits 650 pictured in FIG. 6; these features, such as user interface circuitry, positioning circuits, and the like, are well known to those skilled in the art and are therefore not illustrated.

In some embodiments, processing circuits 630, using appropriate program code 642 stored in memory 640, are configured to implement one or more of the techniques described herein. Of course, not all of the steps of these techniques are necessarily performed in a single microprocessor or even in a single module. Thus, FIG. 7 presents a more generalized view of a mobile station control circuit 700 configured to carry out one or several of the signaling techniques discussed herein. This mobile station control circuit 700 may have a physical configuration that corresponds directly to processing circuits 630, for example, or may be embodied in two or more modules or units, like the configuration illustrated in FIG. 12. In any case, however, control circuit 700, is configured to implement at least three functions. These functions are pictured in FIG. 7 as decoder 710, ACK/NACK codeword generator 720, and radio controller 730.

Decoder 710 detects and decodes data transmitted to the mobile station via multiple carriers, e.g., as many as four HSDPA carriers in a 3GPP Release 10 system. Based upon the carrier configuration (e.g., SISO/SISO, MIMO/MIMO, etc.) and the status of each detected stream (e.g., ACK, NACK), ACK/NACK codeword generator 720 produces one or more ACK/NACK codewords for transmission to the base station in designated slots. Radio controller 730 then sends the ACK/NACK codewords to the wireless base station.

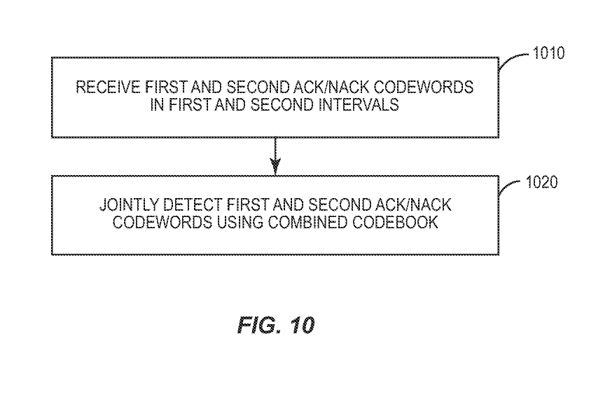

FIG. 8 is a block diagram of a wireless base station 800 configured to receive and process retransmission-related information in a multi-carrier wireless communication system, according to the techniques disclosed herein. In particular, base station 800 may be configured to implement the method illustrated in FIG. 10, or variants thereof. Base station 800 includes a receiver circuit 810, which includes various radio-frequency components (not shown) and a demodulator circuit 812. Receiver 810 processes radio signals received from one or more mobile stations and processes the signals, using known radio processing and signal processing techniques, to convert the received radio signals into digital samples for processing by processor circuits 830. Processing circuits 830 extract data from signals received via receiver 810 and generate information for transmission to the one or more mobile stations via transmitter circuit 620. Like the receiver 810 and demodulator 812, transmitter 820 and modulator 830 use known radio processing and signal processing components and techniques, typically according to a particular telecommunications standard such as the 3GPP standard for Wideband CDMA and multi-carrier HSPA, and are configured to format digital data and generate and condition a radio signal for transmission over the air.

Processing circuits 830 comprise one or several microprocessors 832, digital signal processors, and the like, as well as other digital hardware 834 and memory circuit 840. Memory 840, which comprises one or several types of memory such as read-only memory (ROM), random-access memory, cache memory, flash memory devices, optical storage devices, etc., stores program code 842 for executing one or more telecommunications and/or data communications protocols and for carrying out one or more of the techniques described herein. Memory 840 further stores program data 844 as well as buffered traffic data received from mobile stations and from network interface 850, and also stores various parameters, pre-determined threshold values, and/or other program data for controlling the general operation of the base station 800.

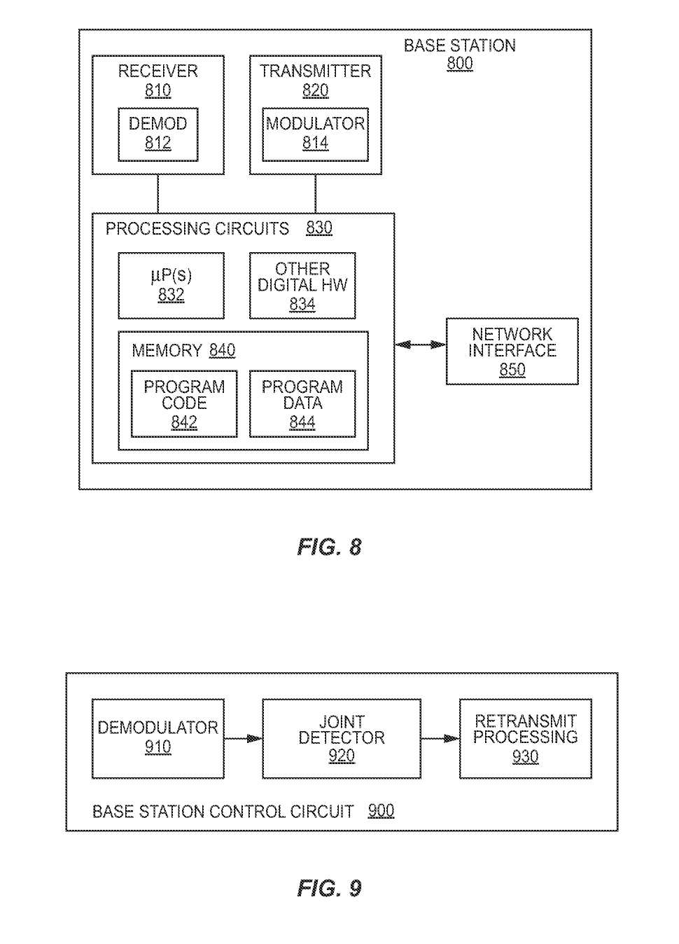

In various embodiments, processing circuits 830, using appropriate program code 842 stored in memory 840, are configured to implement one or more of the retransmission processing techniques described herein. Of course, not all of the steps of these techniques are necessarily performed in a single microprocessor or even in a single module. For instance, while a W-CDMA NodeB may include scheduling functionality that dynamically allocates high-speed packet resources to individual users, other systems may place scheduling or other resource allocation functionality in a physically separate unit. Thus, FIG. 9 presents a more generalized view of a base station control circuit 900 configured to carry out one or several of the flow-control techniques described herein. This base station control circuit 900 may have a physical configuration that corresponds directly to processing circuits 830, for example, or may be embodied in two or more modules or units. In any case, however, base station control circuit 900 is configured to implement at least three functions, which are pictured in FIG. 9 as demodulator 910, joint detector 920, and retransmit processing controller 930.

Demodulator 910 separates the signal received from a given mobile transmitter from other signals and from interference. Joint detector 920 jointly detects ACK/NACK codewords transmitted in two (or more) slots, using one or more of the techniques described above. In a multi-carrier HSPA system using a 1×SF128 format for the HS-DPCCH, for example, these two slots are time-multiplexed slots. If a 2×SF256 format is used, the two slots may be simultaneous, in some embodiments. In any event, the output from the joint detection includes ACK/NACK information for data previously transmitted to the mobile station; this ACK/NACK information is processed by retransmit processing controller 930, which schedules retransmissions of data as necessary.

FIG. 10 illustrates generally a method for processing ACK/NACK feedback formed by any of the techniques described above, such as might be performed using the base station configurations illustrated in FIGS. 8 and 9. This process might be implemented in a NodeB of a system configured for multi-carrier HSDPA, for example. As shown at block 1010, first and second ACK/NACK codewords are received in first and second slots, which are different time intervals (i.e., time-multiplexed slots), in some systems, and/or code-multiplexed in others. As shown at block 1020, the first and second ACK/NACK codewords are jointly detected, using a combined codebook. In systems that employ the codeword repetition approach described earlier, the base station is aware that no carriers in the second subset of carriers were activated. In this case, the base station looks for a combined codeword comprising a repeated codeword in the first and second slots. Otherwise, the base station jointly detects the two codewords, using a codebook that comprises all of the possible combinations of the codewords. In this manner, the detection process is always taking full advantage of the detection energy available to it. In systems that employ the DTX codewords, the joint detection process uses a codebook that combines all of the possible combinations of an ACK/NACK message and a DTX codeword. Again, the detection process is always taking full advantage of the available detection energy.

The various ACK/NACK signaling approaches described above have several advantages. First, these solutions are generally very simple to implement, since they build on the existing Release solution. For some of these approaches, the same coding and codebooks used in Release 9 can be reused.

The first approach described above targets the case when two of the carriers are deactivated, i.e., when only a single subset of two or more subsets of carriers includes activated carriers. To enhance the detection performance, the ACK/NACK information for the subset including one or more activated carriers is repeated in the uplink transmission slot normally allocated for ACK/NACK information for another subset. This is a simple solution that gives a significant performance boost when operating with two out of four carriers, which is an important case in the multi-carrier HSPA system.

In the second approach described above, a DTX codeword is introduced. This DTX codeword should be transmitted when one or the other of two subsets of carriers does not include an activated carrier, in order to boost the NodeB detection performance. This codeword can be added to the current Rel-9 codebook with minimal impact on the standard. Furthermore, the additional NodeB decoding complexity compared to the baseline solution is marginal (one extra codeword). The main benefit is that the 3 dB extra detection energy is obtained without having to deal with special cases arising from imperfect sharing of configuration information between the mobile station and the base station.

Finally a third approach that is not a direct extension of the Release 9 solution was discussed above. In this approach, the ACK/NACK information for two subsets of carriers is jointly coded, while still keeping the number of codewords low. The main benefits with this solution is that it is relatively simple compared to a fully flexible solution and the codebook properties are very good by means of minimum distance properties since we are coding using length-20 codes instead of length-10 codes as in the other approaches. The main drawback is that the decoding complexity increases by the power of two compared to the previous solutions. Furthermore, the Release 9 codebook is not re-used with this approach.

Examples of several embodiments of the present invention have been described in detail above, with reference to the attached illustrations of specific embodiments. Because it is not possible, of course, to describe every conceivable combination of components or techniques, those skilled in the art will appreciate that the present invention can be implemented in other ways than those specifically set forth herein, without departing from essential characteristics of the invention. The present embodiments are thus to be considered in all respects as illustrative and not restrictive, and all modifications and variations that fall within the scope of the appended claims are intended to be embraced therein.

What is claimed is:

1. A method in a wireless transceiver for signaling retransmission-related information in a multi-carrier wireless communication system supporting three or more carriers, the method comprising:
forming a first ACK/NACK group by jointly coding ACK bits and NACK bits for a first subset of the carriers, the first subset comprising at least two of the three or more carriers;
transmitting the first ACK/NACK group during a first transmission slot allocated for the first ACK/NACK group;
selectively also transmitting the first ACK/NACK group during a second transmission slot otherwise allocated to ACK/NACK information for a second subset of the three or more carriers, if no carriers of the second subset are activated for the wireless transceiver for a transmission interval corresponding to the first ACK/NACK group; and
otherwise transmitting a second ACK/NACK group during the second transmission slot, the second ACK/NACK group being formed by jointly coding ACK bits and NACK bits for the second subset.

2. The method of claim 1, wherein the first transmission slot and the second transmission slot are time-multiplexed transmission intervals in an uplink control channel.

3. The method of claim 1, wherein the multi-carrier wireless communication system supports four downlink carriers, wherein forming the first ACK/NACK group comprises jointly coding ACK bits and NACK bits for two of the four downlink carriers, and wherein the first ACK/NACK group is transmitted in both the first transmission slot and the second transmission slot if neither of the remaining two downlink carriers are activated for the wireless transceiver for a downlink transmission interval corresponding to the first ACK/NACK group.

4. The method of claim 1, wherein at least one of the first subset of carriers is configured for multiple-input multiple-output, MIMO, transmission, and wherein jointly coding ACK bits and NACK bits for the first subset of the carriers comprises using a codebook that includes codewords for both MIMO and single-input single-output, SISO, transmission scenarios.

5. The method of claim 4, wherein the codebook used for jointly coding ACK bits and NACK bits for the first subset of the carriers is the codebook specified in Release 9 of the 3GPP standards for High-Speed Downlink Packet Access.

6. A method in a wireless transceiver for signaling retransmission-related information in a multi-carrier wireless communication system supporting three or more carriers, the method comprising:
forming a first ACK/NACK group by jointly coding ACK bits and NACK bits for a first subset of carriers, the first subset comprising at least two of the three or more carriers;
forming a second ACK/NACK group by jointly coding ACK bits and NACK bits for a second subset of carriers, the second subset comprising at least one of the three or more carriers;
transmitting the first ACK/NACK group during a transmission slot allocated for the first ACK/NACK group; and
transmitting the second ACK/NACK group during a transmission slot allocated for the second ACK/NACK group;
wherein the first and second ACK/NACK groups are formed from a codebook comprising a DTX codeword indicating that no data transmission for the wireless transceiver is detected for any carrier of the corresponding subset.

7. The method of claim 6, wherein for any given transmission of the first ACK/NACK group and the second ACK/NACK group, either the first ACK/NACK group or the second ACK/NACK group may comprise the DTX codeword, but not both.

8. The method of claim 6, wherein the codebook comprises the codebook specified for Release 9 of the 3GPP specifications, with the addition of the DTX codeword.

9. The method of claim 6, wherein the DTX codeword comprises the bit sequence [0 0 1 1 0 1 1 0 1 0].

10. The method of claim 6, wherein the DTX codeword comprises the bit sequence [0 0 1 1 0 0 1 0 1 0].

11. The method of claim 6, wherein the first transmission slot and the second transmission slot are time-multiplexed transmission intervals in an uplink control channel.

12. A wireless transceiver configured for signaling retransmission-related information in a multi-carrier wireless communication system supporting three or more carriers, the wireless transceiver comprising
a radio circuit; and
a processing circuit configured to:
form a first ACK/NACK group by jointly coding ACK bits and NACK bits for a first subset of the carriers, the first subset comprising at least two of the three or more carriers, and to transmit the first ACK/NACK group during a first transmission slot allocated for the first ACK/NACK group, via the radio circuit;
selectively also transmit the first ACK/NACK group during a second transmission slot otherwise allocated to ACK/NACK information for a second subset of the carriers, if no carriers of the second subset are active for the wireless transceiver for a transmission interval corresponding to the first ACK/NACK group; and
otherwise transmit a second ACK/NACK group during the second transmission slot, the second ACK/NACK group being formed by jointly coding ACK bits and NACK bits for the second subset of the carriers.

13. The wireless transceiver of claim 12, wherein the first transmission slot and the second transmission slot are time-multiplexed transmission intervals in an uplink control channel.

14. The wireless transceiver of claim 12, wherein the multi-carrier wireless communication system supports four downlink carriers, and wherein the processing circuit is configured to form the first ACK/NACK group by jointly coding ACK bits and NACK bits for two of the four downlink carriers and is further configured to transmit the first ACK/NACK group in both the first transmission slot and the second transmission slot if neither of the remaining two downlink carriers are activated for the wireless transceiver for a downlink transmission interval corresponding to the first ACK/NACK group.

15. The wireless transceiver of claim 14, wherein at least one of the first subset of carriers is configured for multiple-input multiple-output, MIMO, transmission, and wherein the processing circuit is configured to jointly code ACK bits and NACK bits for the first subset of the carriers comprises by using a codebook that includes codewords for both MIMO and single-input single-output, SISO, transmission scenarios.

16. The wireless transceiver of claim 15, wherein the codebook used for jointly coding ACK bits and NACK bits for the first subset of the carriers is the codebook specified in Release 9 of the 3GPP standards for High-Speed Downlink Packet Access.

17. A wireless transceiver configured for signaling retransmission-related information in a multi-carrier wireless communication system supporting three or more carriers, the wireless transceiver comprising
a radio circuit and
a processing circuit, configured to:
form a first ACK/NACK group by jointly coding ACK bits and NACK bits for a first subset of the carriers, the first subset comprising at least two of the three or more carriers;
form a second ACK/NACK group by jointly coding ACK bits and NACK bits for a second subset of the carriers, the second subset comprising at least one of the three or more carriers;
transmit the first ACK/NACK group during a transmission slot allocated for the first ACK/NACK group, using the radio circuit; and
transmit the second ACK/NACK group during a transmission slot allocated for the second ACK/NACK group, using the radio circuit;
wherein the first and second ACK/NACK groups are formed from a codebook comprising a DTX codeword indicating that no data transmission for the wireless transceiver was detected for the corresponding subset.

18. The wireless transceiver of claim 17, wherein the processing circuit (630) is configured so that, for any given transmission of the first ACK/NACK group and the second ACK/NACK group, either the first ACK/NACK group or the second ACK/NACK group may comprise the DTX codeword, but not both.

19. The wireless transceiver of claim 17, wherein the codebook comprises the codebook specified for Release 9 of the 3GPP specifications, with the addition of the DTX codeword.

20. The wireless transceiver of claim 17, wherein the DTX codeword comprises the bit sequence [0 0 1 1 0 1 1 0 1 0].

21. The wireless transceiver of claim 17, wherein the DTX codeword comprises the bit sequence [0 0 1 1 0 0 1 0 1 0].

22. The wireless transceiver of claim 17, wherein the first transmission slot and the second transmission slot are time-multiplexed transmission intervals in an uplink control channel.

23. A method, in a wireless base station configured for multi-carrier operation with three or more carriers, the method comprising:
demodulating two transmission slots in a received control channel signal, each transmission slot containing ACK/NACK information for a mobile station corresponding to a subset of two or more of the three or more carriers; and
jointly detecting the demodulated fields.

24. The method of claim 23, wherein jointly detecting the demodulated fields comprises using a codebook that includes repeated codewords in the two transmission slots.

25. The method of claim 23, wherein jointly detecting the demodulated fields comprises using a codebook that includes a DTX codeword for each field, the DTX codeword indicating that no transmission for the mobile station was detected on carriers of the carrier subset corresponding to the field.

26. A wireless base station configured for multi-carrier operation with three or more carriers, the base station comprising a processing circuit configured to:
demodulate two transmission slots in a received control channel signal, each transmission slot containing ACK/NACK information for a mobile station corresponding to a subset of two or more of the three or more carriers; and
jointly detect the demodulated fields.

27. The wireless base station of claim 26, wherein the processing circuit is configured to jointly detect the demodulated fields using a codebook that includes repeated codewords in the two transmission slots.

28. The wireless base station of claim 26, wherein the processing circuit is configured to jointly detect the demodulated fields using a codebook that includes a DTX codeword for each field, the DTX codeword indicating that no transmission for the mobile station was detected on carriers of the carrier subset corresponding to the field.
